(19) United States
(12) Patent Application Publication
(10) Pub. No.: US 2011/0274769 A1
(43) Pub. Date: Nov. 10, 2011

(54) Antibacterial Melamine Product

(76) Inventor: Xing-Yi Chen, Yongkang City (TW)

(21) Appl. No.: 12/773,144

(22) Filed: May 4, 2010

(51) Int. Cl. A01N 59/16; A01N 59/06

(52) U.S. Cl. 424/641; 424/617; 424/688; 424/692

(57) ABSTRACT

An antibacterial melamine product includes a main body that is formed by heating and filling molding to have a predetermined shape. The main body includes a substrate portion and an antibacterial agent mixed with the substrate portion. The substrate portion is made of melamine formaldehyde. The antibacterial agent is fused in the substrate portion evenly. Thus, the antibacterial agent is mixed with the substrate portion to form the main body so that the main body of the antibacterial melamine product has different antibacterial effects by the antibacterial features provided by the antibacterial agent.

### BACKGROUND OF THE INVENTION

1. Field of the Invention

The present invention relates to a melamine product, such as a melamine dishware and the like, and, more particularly, to an antibacterial melamine product that is made of melamine formaldehyde or melamine resin.

2. Description of the Related Art

A melamine product has many features. For example, the melamine product is nontoxic, odorless and wear-resistant, has a greater surface hardness, can tolerate a higher temperature and will not cause an environmental pollution. Thus, the melamine product can be made into a dishware, bowl, disc, cup, knife, fork, spoon and the like. In addition, the melamine product is added with bamboo charcoal to have an antibacterial effect. However, when the bamboo charcoal is added into and mixed with the thermosetting resin of the melamine product, the color of the melamine product is not evenly distributed due to the black color of the bamboo charcoal, thereby decreasing the aesthetic quality of the melamine product. In addition, it is difficult to decolorize the bamboo charcoal in the melamine product, thereby increasing the cost of fabrication of the melamine product.

### BRIEF SUMMARY OF THE INVENTION

In accordance with the present invention, there is provided an antibacterial melamine product, comprising a main body that is formed by heating and filling molding to have a predetermined shape. The main body includes a substrate portion and an antibacterial agent mixed with the substrate portion. The substrate portion is made of melamine formaldehyde. The antibacterial agent is fused in the substrate portion evenly.

Preferably, the antibacterial agent is made of an inorganic antibacterial material, an organic antibacterial material or a metallic oxide antibacterial material.

According to the primary objective of the present invention, the antibacterial agent is mixed with the substrate portion to form the main body so that the main body of the antibacterial melamine product has different antibacterial effects by the antibacterial features provided by the antibacterial agent.

According to another objective of the present invention, the antibacterial agent is mixed with the substrate portion evenly so that the main body of the antibacterial melamine product has evenly and smoothly distributed colors to enhance the aesthetic quality of the antibacterial melamine product.

According to a further objective of the present invention, the main body of the antibacterial melamine product is made easily and quickly to decrease the costs of fabrication of the antibacterial melamine.

According to a further objective of the present invention, the antibacterial agent is mixed with the substrate portion by a proper proportion that is in a safe range so that the main body of the antibacterial melamine product satisfies the healthy standard so as to protect the user's health.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an antibacterial melamine product in accordance with the preferred embodiment of the present invention.

FIG. 2 is a perspective view of an antibacterial melamine product in accordance with another preferred embodiment of the present invention.

FIG. 3 is a perspective view of an antibacterial melamine product in accordance with another preferred embodiment of the present invention.

### DETAILED DESCRIPTION OF THE INVENTION

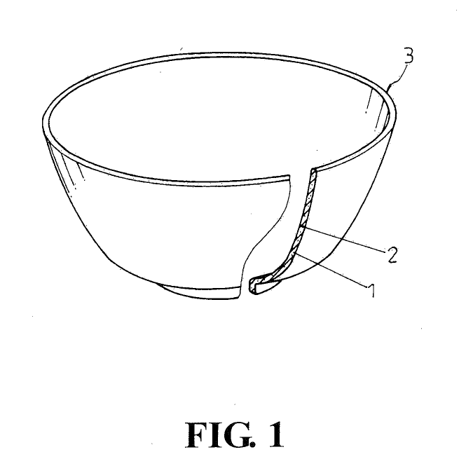

Referring to the drawings and initially to FIG. 1, an antibacterial melamine product in accordance with the preferred embodiment of the present invention comprises a main body 3 that is formed by heating and filling molding to have a predetermined shape. The main body 3 includes a substrate portion 1 and an antibacterial agent 2 mixed with the substrate portion 1. The substrate portion 1 is made of melamine formaldehyde. The antibacterial agent 2 is fused in the substrate portion 1 evenly.

The antibacterial agent 2 may be made of an inorganic antibacterial material, an organic antibacterial material or a metallic oxide antibacterial material.

In the preferred embodiment of the present invention, the inorganic antibacterial material of the antibacterial agent 2 is chosen from the group of an antibacterial material containing metallic ions, an antibacterial material containing a TiO₂ (titanium dioxide) optical catalyst and an antibacterial material having a far-infrared radiation function. In such a manner, when the inorganic antibacterial material of the antibacterial agent 2 is mixed with the substrate portion 1, the proportion of the substrate portion 1 is about 70% to 75%, and the proportion of the antibacterial agent 2 is about 30% to 25%.

In the preferred embodiment of the present invention, the organic antibacterial material of the antibacterial agent 2 is chosen from the group of a chemical synthetic antibacterial material and a natural antibacterial material. In such a manner, when the organic antibacterial material of the antibacterial agent 2 is mixed with the substrate portion 1, the proportion of the substrate portion 1 is about 70% to 69.5%, and the proportion of the antibacterial agent 2 is about 30% to 30.5%.

In the preferred embodiment of the present invention, the metallic oxide antibacterial material of the antibacterial agent 2 is chosen from the group of MgO (magnesium oxide), CaO (calcium oxide), ZnO (zinc oxide) and calcium-made material. In such a manner, when the metallic oxide antibacterial material of the antibacterial agent 2 is mixed with the substrate portion 1, the proportion of the substrate portion 1 is about 99.8% to 99.5%, and the proportion of the antibacterial agent 2 is about 0.2% to 0.5%.

Thus, when the antibacterial agent 2 is mixed with the substrate portion 1 to form the main body 3, the main body 3 has different antibacterial actions and effects by the different antibacterial features provided by the antibacterial agent 2.

In fabrication, when the antibacterial agent 2 is mixed with the substrate portion 1 evenly to form a mixture, the mixture is heated at the temperature of 170° C. to 180° C. Then, the mixture is processed by filling molding. After the mixture is solidified, the main body 3 is formed to have a predetermined shape. Thus, the main body 3 contains the antibacterial agent 2 to have an antibacterial effect.

As shown in FIG. 1, the main body 3 has a bowl shape.

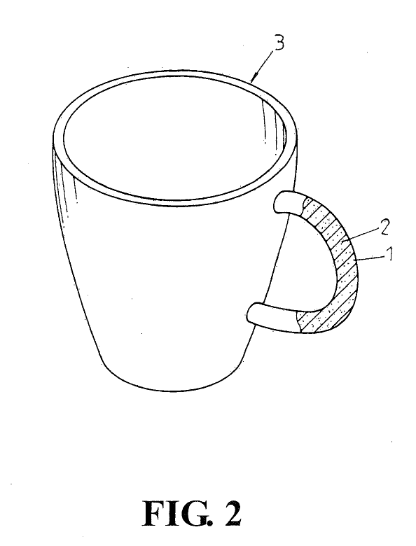

As shown in FIG. 2, the main body 3 has a cup shape.

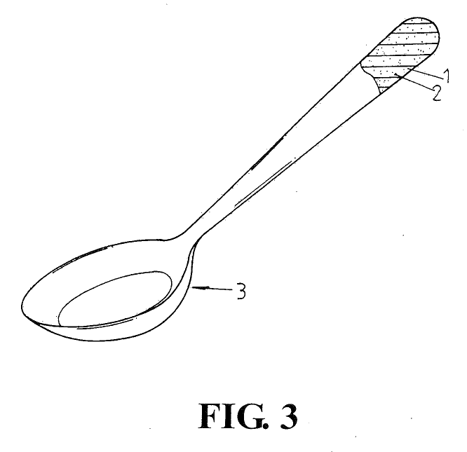

As shown in FIG. 3, the main body 3 has a spoon shape.

Accordingly, the antibacterial agent 2 is mixed with the substrate portion 1 to form the main body 3 so that the main body 3 of the antibacterial melamine product has different antibacterial effects by the antibacterial features provided by the antibacterial agent 2. In addition, the antibacterial agent 2 is mixed with the substrate portion 1 evenly so that the main body 3 of the antibacterial melamine product has evenly and smoothly distributed colors to enhance the aesthetic quality of the antibacterial melamine product. Further, the main body 3 of the antibacterial melamine product is made easily and quickly to decrease the costs of fabrication of the antibacterial melamine. Further, the antibacterial agent 2 is mixed with the substrate portion 1 by a proper proportion that is in a safe range so that the main body 3 of the antibacterial melamine product satisfies the healthy standard so as to protect the user's health.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An antibacterial melamine product, comprising:
a main body that is formed by heating and filling molding to have a predetermined shape;
wherein the main body includes a substrate portion and an antibacterial agent mixed with the substrate portion;
the substrate portion is made of melamine formaldehyde;
the antibacterial agent is fused in the substrate portion evenly.

2. The antibacterial melamine product of claim 1, wherein the antibacterial agent is made of an inorganic antibacterial material, an organic antibacterial material or a metallic oxide antibacterial material.

3. The antibacterial melamine product of claim 1, wherein
the antibacterial agent is made of an inorganic antibacterial material;
the inorganic antibacterial material of the antibacterial agent 2 is chosen from the group of an antibacterial material containing metallic ions, an antibacterial material containing a TiO₂ (titanium dioxide) optical catalyst and an antibacterial material having a far-infrared radiation function.

4. The antibacterial melamine product of claim 1, wherein
the antibacterial agent is made of an organic antibacterial material;
the organic antibacterial material of the antibacterial agent 2 is chosen from the group of a chemical synthetic antibacterial material and a natural antibacterial material.

5. The antibacterial melamine product of claim 1, wherein
the antibacterial agent is made of a metallic oxide antibacterial material;
the metallic oxide antibacterial material of the antibacterial agent 2 is chosen from the group of MgO (magnesium oxide), CaO (calcium oxide), ZnO (zinc oxide) and calcium-made material.
